(19) United States
(12) Patent Application Publication
(10) Pub. No.: US 2016/0150848 A1
(43) Pub. Date: Jun. 2, 2016

(54) MULTI-COLORED OPTICAL FIBER SHOE LAMP

(71) Applicant: JIN CHUN HE, FUJIAN PROVINCE (CN)

(72) Inventor: QUAN TANG, FUJIAN PROVINCE (CN)

(21) Appl. No.: 14/556,456

(22) Filed: Dec. 1, 2014

(51) Int. Cl. A43B 3/00; F21V 33/00; F21V 8/00

(52) U.S. Cl. CPC A43B 3/001; G02B 6/0008; F21V 33/0008; F21Y 2101/02

(57) ABSTRACT

A multi-colored optical fiber shoe lamp has a control unit, a plurality of light emitting units and a plurality of light guiding units. Each of the light emitting units can emit at least two colored lights, and the control unit includes a launch unit and a time-sequence control unit. The launch unit senses a jolt action to generate a pulse signal to deliver to the time-sequence control unit, and the time-sequence control unit receives the pulse signal from the launch unit so as to control the time sequence of each of the light emitting units for emitting lights according to the pulse signal. Each of the light emitting unit is connected to one light guiding unit so as to guide and emit the light from the end of the corresponding light guiding unit.

### BACKGROUND OF THE INVENTION

1. Field of the Invention

The present invention relates to a shoe lamp, and more particularly to an optical fiber shoe lamp that emits multiple colors.

2. Description of the Prior Art

A conventional shoe structure includes a lamp body assembled thereto, called shoe lamp, so that the shoe structure emits light via the lamp body for decorative purposes or for alerting. However, the lamp body can only emit a single color; furthermore, even if blinking can be performed by such lamp body, the monochromatic lamp body can only perform monotone light emitting and fails to be effectively decorative and apparently alertive.

The present invention is, therefore, arisen to obviate or at least mitigate the above mentioned disadvantages.

### SUMMARY OF THE INVENTION

An object of the present invention is to provide a multi-colored optical fiber shoe lamp triggered by the jolt while walking so as to emit colored lights with different blinking frequencies, thus being colorful and apparently alertive.

To achieve the above and other objects, the multi-colored optical fiber shoe lamp comprises a plurality of light emitting units, a control unit, a plurality of light guiding units and a switch. Each of the light emitting units emits at least two colored lights. The control unit is electrically connected to each of the light emitting units. The control unit comprises a time-sequence control unit, a power supply unit and a launch unit. The power supply unit serves electricity to the control unit and the light emitting units. The launch unit senses a jolt action to generate a pulse signal to deliver to the time-sequence control unit, and the time-sequence control unit receives the pulse signal from the launch unit so as to control the time sequences of each of the light emitting units for emitting lights according to the pulse signal. Each of the light guiding units has an entrance end and an exit end. The entrance ends of the light guiding units are connected to the light emitting units, respectively, so as to guide the lights of the light emitting units to the exit ends, respectively. The switch is electrically connected to the control unit so as to turn on or turn off the control unit.

Wherein, each of the light emitting units comprises at least a first lamp body and a second lamp body, the first lamp body and the second lamp body are LEDs, and the color of the light emitted from the first lamp body is different from that emitted from the second lamp body. Every time when the time-sequence control unit receives the pulse signal from the launch unit, the time-sequence control unit controls the first lamp body to emit light with a first blinking frequency in a first time interval and controls the second lamp body to emit light with a second blinking frequency in a second time interval.

Preferably, each of the light guiding units comprises a plurality of optical fibers wrapped and collected by a heat shrinkable tubing, the light emitting units are also enclosed by the heat shrinkable tubings, respectively.

Furthermore, the exit end of each of the light guiding units is connected to a decorative unit. The decorative unit is provided with a picture thereon. A plurality of positioning holes is opened at the picture. The exit ends of the light guiding units are connected to the positioning holes, respectively. Additionally, the exit end of each of the light guiding units protrude out of the corresponding positioning hole to form a head portion being expanded, and the outer diameters of the head portions are larger than the diameters of the positioning holes, respectively.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic view showing a multi-colored optical fiber shoe lamp according to the present invention is assembled to a shoe;

FIG. 2 is a perspective view of the multi-colored optical fiber shoe lamp of the present invention;

FIG. 3 is a diagram of the circuit layout of the multi-colored optical fiber shoe lamp of the present invention;

FIG. 4 is a schematic view showing the emitting time sequence of the light emitting units of the multi-colored optical fiber shoe lamp of the present invention;

FIG. 5 is a partially enlarged cross-sectional view of circle A shown in FIG. 2;

FIG. 6 is a partially enlarged cross-sectional view of circle B shown in FIG. 2; and

FIG. 7 is a partially enlarged cross-sectional view of circle C shown in FIG. 6.

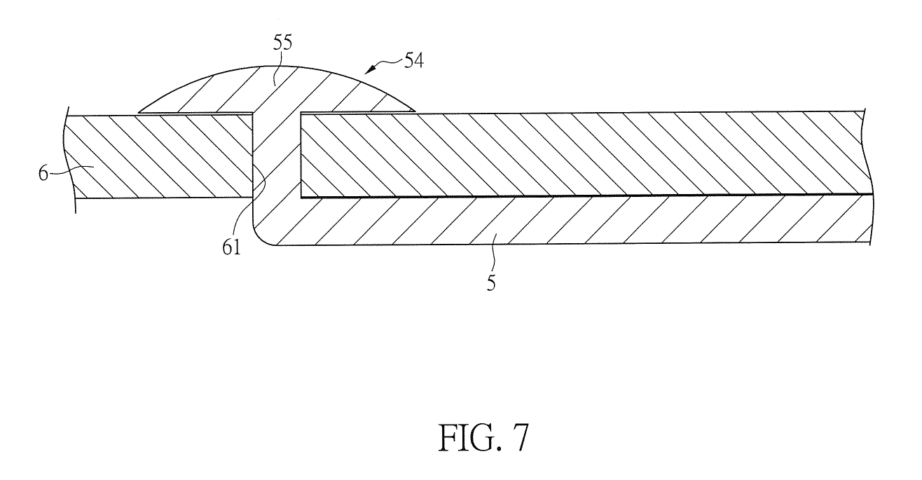

### DETAILED DESCRIPTION OF THE PREFERRED EMBODIMENTS

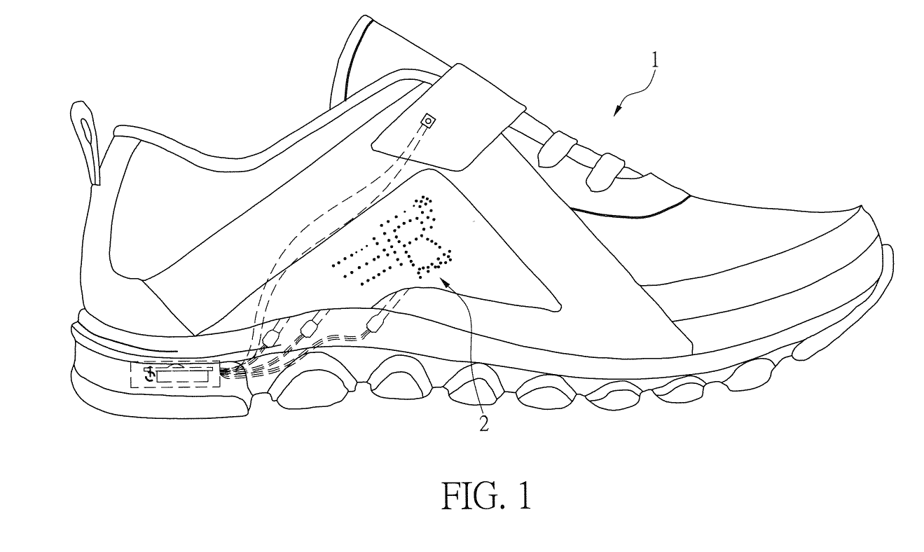

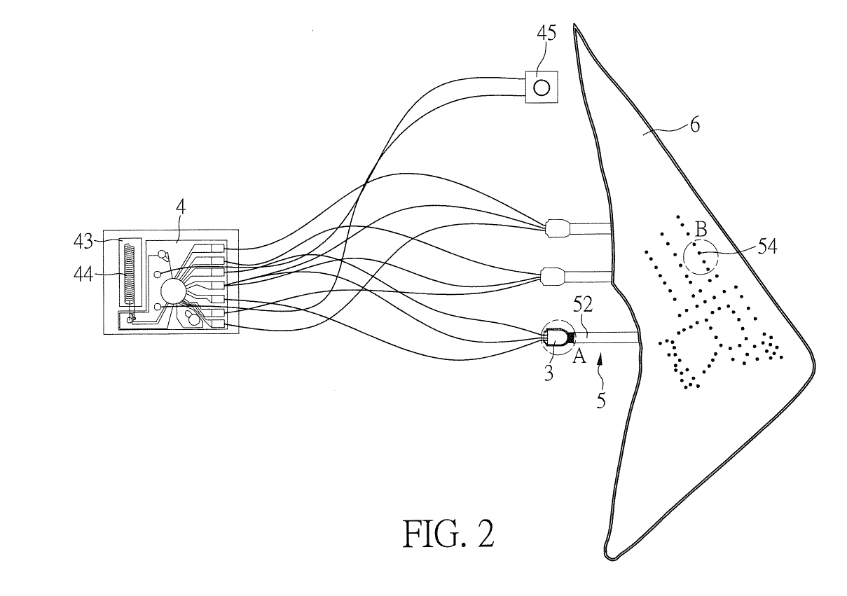

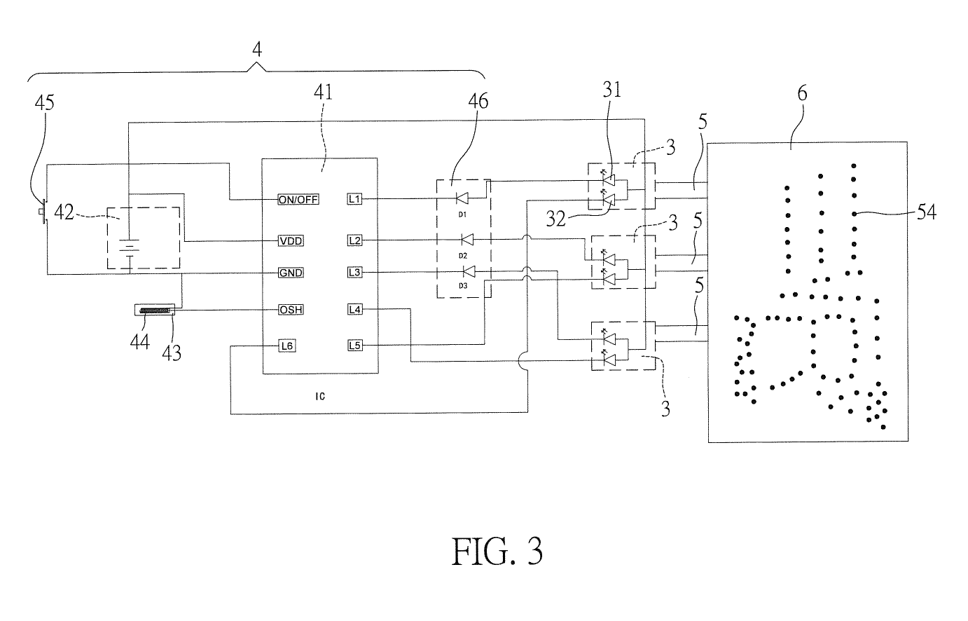

Referring to FIG. 1, an embodiment in accordance with a multi-colored optical fiber shoe lamp 2 of the present invention is described as follows. The multi-colored optical fiber shoe lamp 2 is assembled to the surface of shoes 1; particularly, the multi-colored optical fiber shoe lamp 2 is assembled to boots or athletic shoes. The multi-colored optical fiber shoe lamp 2 serves to be decorative and striking via the blinking function thereof. As shown in FIG. 2 and FIG. 3, the multi-colored optical fiber shoe lamp 2 according to the present invention mainly comprise a control unit 4, a plurality of light emitting units 3 and a plurality of light guiding units 5, which are described as follows.

Each of the light emitting units 3 can emit at least two different colored lights. In this embodiment, each of the light emitting units 3 comprises a first lamp body 31 and a second lamp body 32. Both of the first lamp body 31 and the second lamp body 32 are light emitting diodes, and the color of the light emitted from the first lamp body 31 is different from that emitted from the second lamp body 32. For example, the first lamp body 31 emits blue colored light while the second lamp body 32 emits green colored light. In this embodiment, the number of the light emitting unit 3 is three, thus the three light emitting units 3 have three first lamp bodies 31 and three second lamp bodies 32, respectively.

The control unit 4 is electrically connected to each of the light emitting units 3 so as to control the operation of the light emitting units 3, respectively. The control unit 4 comprises a time-sequence control unit 41, a power supply unit 42 and a launch unit 43. The power supply unit 42 can be a rechargeable battery or a disposable battery provided to serve electricity to the control unit 4 and the light emitting units 3. The time-sequence control unit 41 comprises an isolated or integrated circuit chip and auxiliary circuits around the circuit chip. The time-sequence control unit 41 comprises connecting ports L1 to L6, each respectively and electrically connected to the light emitting units 3. The connecting ports L1 to L3 are respectively connected to the first lamp body 31 of each of the light emitting units 3, and the connecting ports IA to L6 are respectively connected to the second lamp body 32 of each of the light emitting units 3. Based on this, the time-sequence control unit 41 respectively controls the time sequences of each of the light emitting units 3 for emitting lights

Furthermore, the control unit 4 further comprises a voltage balancing unit 46. The voltage balancing unit 46 comprises a plurality of diodes. Breakover voltage drops of the diodes are added to the circuit of each of the light emitting units 3, so that the luminescence of the light emitted from the first lamp body 31 is the same as that emitted from the second lamp body 32 for each of the light emitting units 3, and the time interval of the light emitted from the first lamp body 31 is the same as that emitted from the second lamp body 32 for each of the light emitting units 3.

A spring 44 is assembled on a launch circuit configured in the launch unit 43. When a user who wearing the shoes 1 with the multi-colored optical fiber shoe lamp 2 according to the present invention walks or runs, due to the weight of the shoes 1 themselves and an acceleration induced by the user upon making step, the multi-colored optical fiber shoe lamp 2 according to the present invention is jolted so that the spring 44 vibrates longitudinally, resulting in shortcut of the launch circuit to generate a rectangular pulse signal. The pulse signal is then delivered to the time-sequence control unit 41 to control the time sequences of each of the light emitting units 3 for emitting lights. Moreover, a switch 45 is electrically connected to the control unit 4; when the switch 45 is turned on, the launch unit 43 functions. The action that the launch unit 43 generates the pulse signal is continuously and repeatedly occurring during the user walking or running, therefore, the time-sequence control unit 41 continuously and repeatedly controls each of the light emitting units 3.

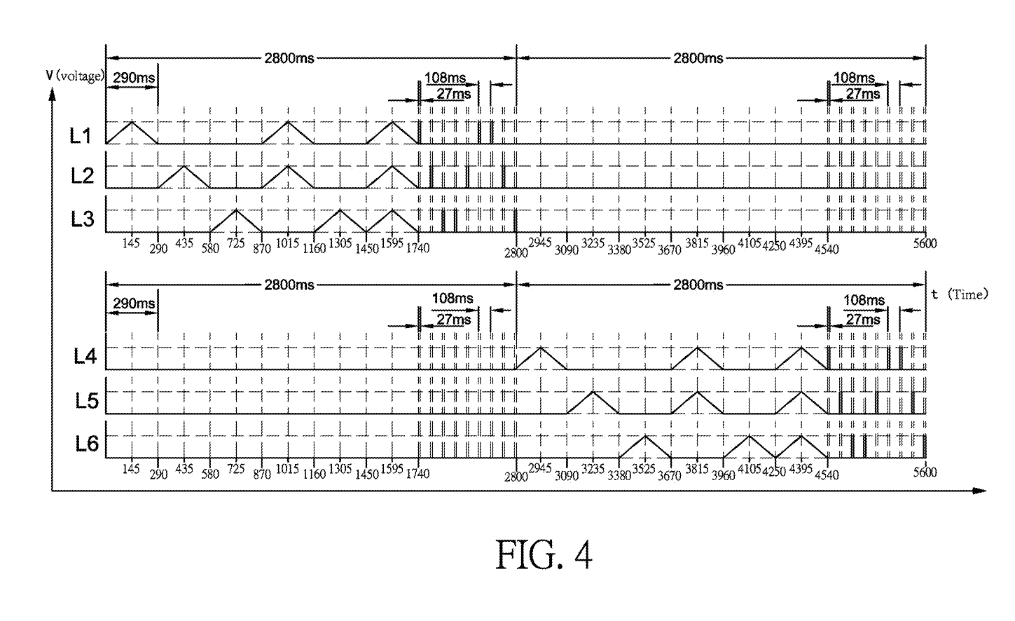

As mentioned above, every time when the time-sequence control unit 41 receives the pulse signal from the launch unit 43, the time-sequence control unit 41 sends control signals to the first lamp body 31 and the second lamp body 32 of each of the light emitting units 3 through the connecting ports L1 to L6. Hence, the time-sequence control unit 41 controls the first lamp body 31 to emit light with a first blinking frequency in a first time interval and controls the second lamp body 32 to emit light with a second blinking frequency in a second time interval. FIG. 4 shows the emitting time sequence for each of the light emitting units 3 of the multi-colored optical fiber shoe lamp 2 of the present invention; in which the first time interval and the second time interval are respectively 2800 milliseconds, and the first time interval is linked to the second time interval in a time line to form a period. The time-sequence control unit 41 respectively controls each of the first lamp bodies 31 and each of the second lamp bodies 32 to continuously emit light lasting for 290 milliseconds at different timing, so that the light emitting units 3 are emitting lights alternately (the light emitting units 3 are blinking). Furthermore, as shown in FIG. 4, the three first lamp bodies 31 are emitting lights in an alternate manner, a simultaneous manner or the combination thereof; similarly, the three second lamp bodies 32 are emitting lights in an alternate manner, a simultaneous manner or the combination thereof.

The emitting time sequence of the light emitting units 3 is described as follows. Firstly, within the time interval from 0 to 290 milliseconds, the first lamp body 31 controlled by the connecting port L1 emits light, while the first lamp bodies 31 controlled by the connecting port L2 and L3 do not emit lights; the luminescence of the light emitted from the first lamp body 31 controlled by the connecting port L1 is gradually increased from 0 to 145 milliseconds, and the luminescence of the light emitted from the first lamp body 31 controlled by the connecting port L1 is then gradually reduced and turned off eventually from 146 to 290 milliseconds. And then, within the time interval from 291 to 580 milliseconds, the first lamp body 31 controlled by the connecting port L2 emits light, while the first lamp bodies 31 controlled by the connecting ports L1 and L3 do not emit lights, and the luminescence variation of the light emitted from the first lamp body 31 controlled by the connecting port L2 is the similar to that of the light emitted from the first lamp body 31 controlled by the connecting port L1. Within the time interval from 581 to 870 milliseconds, only the first lamp body 31 controlled by the connecting port L3 emits light. And then, within the time interval from 871 to 1160 milliseconds, the first lamp bodies 31 controlled by the connecting ports L1 and L2 emit light simultaneously, while the first lamp body 31 controlled by the connecting port L3 does not emit light. And, within the time interval from 1161 to 1450 milliseconds, only the first lamp body 31 controlled by the connecting port L3 emits light. Further, within the time interval from 1451 to 1740 milliseconds, all the first lamp bodies 31 emit light simultaneously. And then, within the time interval from 1741 to 2800 milliseconds, the first lamp bodies 31 are alternately turned on and off to perform blinking. During the time interval from 1741 to 2800 milliseconds, the light duration time for each of the first lamp bodies is 27 milliseconds, and the blinking frequency is 108 milliseconds.

When the first time interval is finished, the second time interval starts. The emitting time sequence of the light emitting units 3 within the first time interval is the same as that within the first time interval except that within the second time interval, the second lamp bodies 32 controlled by the connecting ports L4 to L6 emit light. Based on this, within the period combined by the first time interval and the second time interval, since the colors emitted by the first lamp bodies 31 are different from that emitted by the second lamp bodies 32, a vision that two colored lights blink alternately can be performed so as to improve the diversity of the light change, the decoration of the shoes 1 and the warning ability for being used at night.

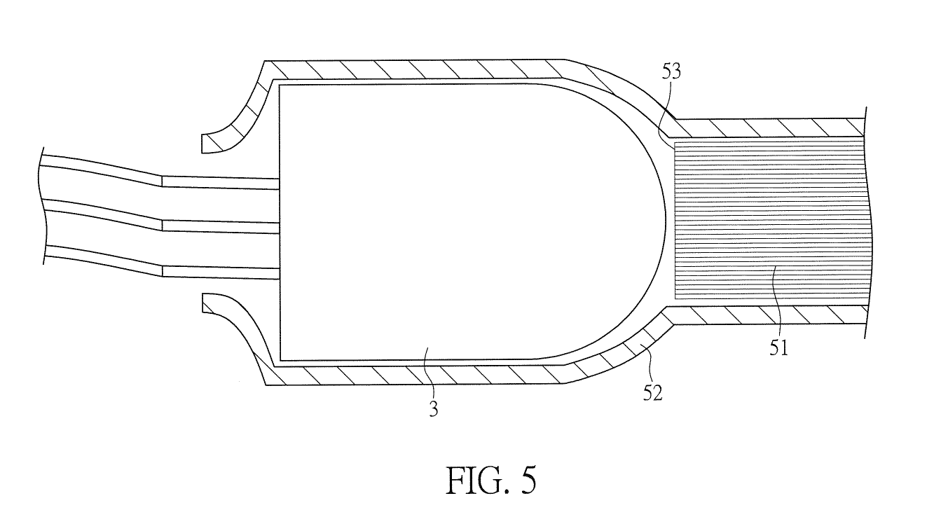

After each of the light emitting units 3 is controlled and emits light, the light is then guided to a decorative unit 6 through a light guiding unit 5. In detail, as shown in FIG. 2 and FIG. 5, each of the light emitting units 3 is respectively connected to one light guiding unit 5. In this embodiment, each of the light guiding units 5 comprises optical fibers 51 with length between 50 to 200 millimeters, and the optical fibers 51 are wrapped and collected by a heat shrinkable tubing 52. Each of the light guiding units 5 has an entrance end 53 and an exit end 54; the entrance ends 53 of the light guiding units 5 are connected to the light emitting units 3, respectively, the light emitting unis 3 are also enclosed by the heat shrinkable tubings 52, respectively, so that the light emitting units 3 and the light guiding units 5 are securely connected with each other, respectively, via the heat shrinkable tubings 52 to prevent the light delivered by the optical fibers 51 of each of the light guiding units 5 from being exposed to outside. Based on this, the lights emitted from the light emitting units 3 are guided by the light guiding units 5 so as to be emitted from the exit ends 54 of the light guiding units 5, respectively.

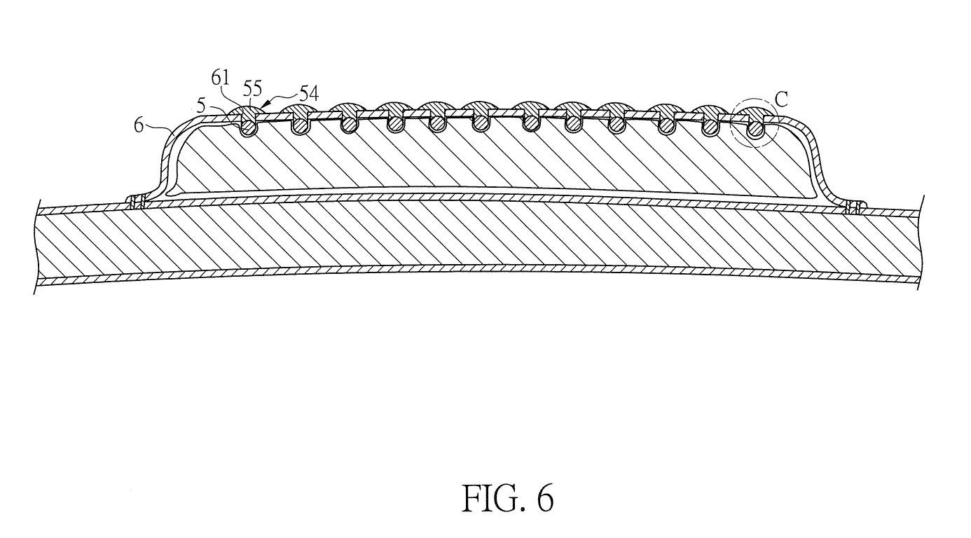

Accordingly, as shown in FIG. 6, the exit end 54 of each of the light guiding units 5 is connected to a decorative unit 6. The decorative unit 6 is a decorative sheet provided to attach to the surfaces of shoes; the decorative unit 6 is provided with a picture thereon, and a plurality of positioning holes 61 is opened at the picture, and the exit ends 54 of the light guiding units 5 are connected to the positioning holes 61, respectively. In this embodiment, the exit end 54 of each of the light guiding units 5 protrude out of the corresponding positioning hole 61 to form a head portion 55 being expanded, and the outer diameters of the head portions 55 are larger than the diameters of the positioning holes 61, respectively; that is, the exit end 54 and the head portion 55 of each of the light guiding units 5 form a profile similar to a rivet to be fastened with the corresponding positioning hole 61, respectively. Based on this, the exit ends 54 of the light guiding units 5 are aligned to form the outline of the picture, so that the decorative unit 6 not only emits light blinkingly, but also show the outline of the picture by the lights emitted therefrom.

Accordingly, the present invention has several advantages provided as follows.

Firstly, long duration: by using the switch 45, the control unit 4 can be turned off or turned on according to ambient luminescence. Based on this, not only the time for using the present invention can be managed efficiently, but also the use of batteries can be retarded so as to approach eco-friendly.

Secondly, highly decorative and alertive: by using the time-sequence control unit 41, the emission of the light emitting units 3 is allowed to be controlled by a specific time sequence, so that different lights are alternately emitting or blinking so as to improve the decoration of the shoes and the warning ability for being used at night.

Thirdly, easy to be assembled and high flexibility: since the decorative unit 6 is a part of the surface of the shoes, the decorative unit 6 can be stitched on the surfaces of the shoes by simple stitching machinery, and the position of the decorative unit 6 to be stitched can be chosen freely according to the design of the surfaces of the shoes.

Although particular embodiments of the invention have been described in detail for purposes of illustration, various modifications and enhancements may be made without departing from the spirit and scope of the invention. Accordingly, the invention is not to be limited except as by the appended claims.

1. A multi-colored optical fiber shoe lamp, comprising:
a plurality of light emitting units, each of the light emitting units provided to emit at least two colored lights;
a control unit, electrically connected to each of the light emitting units, respectively, the control unit comprising a time-sequence control unit, a power supply unit and a launch unit, wherein the power supply unit is provided to serve electricity to the control unit and the light emitting units, the launch unit senses a jolt action to generate a pulse signal to deliver to the time-sequence control unit, and the time-sequence control unit is provided to receive the pulse signal from the launch unit so as to control the time sequences of each of the light emitting units for emitting lights according to the pulse signal;
a plurality of light guiding units, each having an entrance end and an exit end, the light guiding units respectively connected to the light emitting units via the entrance ends of the light guiding units so as to respectively guide the lights of the light emitting units to the exit ends of the light guiding units; and
a switch, electrically connected to the control unit, the switch provided to turn on or turn off the control unit.

2. The multi-colored optical fiber shoe lamp as claimed in claim 1, wherein each of the light emitting units comprises at least a first lamp body and a second lamp body, the first lamp body and the second lamp body are LEDs, and the color of the light emitted from the first lamp body is different from the color of the light emitted from the second lamp body.

3. The multi-colored optical fiber shoe lamp as claimed in claim 2, wherein every time when the time-sequence control unit receives the pulse signal from the launch unit, the time-sequence control unit controls the first lamp body to emit light with a first blinking frequency in a first time interval and controls the second lamp body to emit light with a second blinking frequency in a second time interval.

4. The multi-colored optical fiber shoe lamp as claimed in claim 3, wherein the first time interval is linked to the second time interval in a time line to form a period.

5. The multi-colored optical fiber shoe lamp as claimed in claim 1, wherein the control unit further comprises a voltage balancing unit, the voltage balancing unit comprises a plurality of diodes, wherein breakover voltage drops of the diodes are added to the circuit of each light emitting unit, so that the luminescence of the lights for each light emitting unit are the same and the time interval of the lights for each light emitting unit are the same.

6. The multi-colored optical fiber shoe lamp as claimed in claim 1, wherein each of the light guiding units comprises a plurality of optical fibers, the optical fibers of each of the light emitting units are wrapped and collected by a heat shrinkable tubing, the light emitting units are also enclosed by the heat shrinkable tubings, respectively.

7. The multi-colored optical fiber shoe lamp as claimed in claim 1, wherein the exit end of each light guiding unit is connected to a decorative unit, the decorative unit is provided with a picture thereon, a plurality of positioning holes is opened at the picture, and the exit ends of the light guiding units are connected to the positioning holes, respectively.

8. The multi-colored optical fiber shoe lamp as claimed in claim 7, wherein the exit end of each of the light guiding units protrude out of the corresponding positioning hole to form a head portion being expanded, and the outer diameters of the head portions are larger than the diameters of the positioning holes, respectively.
